(19) United States
(12) Patent Application Publication
(10) Pub. No.: US 2003/0120590 A1
(43) Pub. Date: Jun. 26, 2003

(54) Electronic settlement method and system

(75) Inventors: Takeshi Ieshima, Yokohama (JP); Seiji Futatsugi, Kawasaki (JP); Masahiro Sakashita, Yokosuka (JP); Yuuji Ide, Yokohama (JP); Ken Nozaki, Machida (JP); Takeshi Yokota, Hitachi (JP); Ryoji Satoh, Tokyo (JP); Masao Nishida, Kokubunji (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/196,501

(22) Filed: Jul. 15, 2002

(30) Foreign Application Priority Data
Dec. 21, 2001 (JP) 2001-389901

(51) Int. Cl. G06F 17/60

(52) U.S. Cl. 705/38

(57) ABSTRACT

An electronic settlement system processes settlements that are conducted using credit cards through a communication line connecting a server of a credit card company to card-processing devices of member stores or terminals of customers. The electronic settlement system includes a device that provides personal information of customers to member stores based on the agreement by the customers to provide such personal information, and a device that provide the customers with preferred services either from the credit card company or the member stores in exchange for the personal information provided. Furthermore, the electronic settlement system may includes a device at the card company to receive fees for providing the member stores with the personal information of the customers. The electronic settlement system enables the customers to receive services, the member stores to utilize accurate personal information, and the card company to receive fees from the member stores.

### BACKGROUND OF THE INVENTION

1. Field of the Invention

The present invention relates to an electronic settlement method and system, and more particularly to an electronic settlement method and system using credit cards, cash cards, monetary cards, and other similar cards. References to “credit cards” includes cash cards, monetary cards, and other similar cards.

2. Description of Related Art

Electronic settlements using credit cards are commonly used. These electronic settlements use credit cards held by users, or customers and may be typically carried out in the following manner.

First, the user inputs the price and type of the purchased merchandise into a card-processing device often located next to a cash register of a member store. Such input is normally performed by a store clerk in charge of casher registers. Next, the clerk slides the credit card held by the customer through the device, it inquires a bank or a credit card company through its processing system connected to the card-processing device to determine if such purchase can be authorized. For this, each credit card has a magnetic area and/or a IC memory device, which maintain customer credit information (such as the customer control number used by a credit card company and password). The server system analyzes if the customer will be able to pay for the purchase, and returns the result. Based on this analysis, if the system authorizes, the customer can receive the merchandise with his signature. Also, the server system maintains specific details necessary to withdraw a fund from the customer's bank account.

In addition, at websites where electronic transactions are performed, credit cards are often used as a means of settlements.

When such electronic settlement is performed, member stores or member sites, to improve their services, wish to identify customers who are regularly purchasing particular merchandises or using particular stores and inform them on the stores' campaigns based on their home address and income level, etc. For this reason, member stores and member sites have been attempting to build their own customer information management system, to accumulate the merchandise sales data and to analyze such data.

Information that can be input through cash registers, however, is generally basic (such as the gender and age) and it is difficult to capture the name, address, and income level of customers who are making purchases at the point of purchases. As such, member stores, to specify customers as individuals, receive customer information by providing them with services such as setting up member reward programs.

Also, member sites using electronic settlements generally require a customer to input the credit card number as well as his or her name, address, and gender and to register as an user when he uses the site for the first time.

Even with this method, however, it is still difficult to collect family information and annual income, and there are limited ways to ensure the information input is correct. In addition, if personal information is changed, many customers don't take their time to input new information by re-registering.

On the other hand, credit card companies perform settlement with customers through financial institutions such as banks, thus, maintain detail personal information such as family information, occupation, and annual income. Such personal information can not be released to member stores without customers' approval and credit card companies do not have any reason to do so. As such, member stores can only obtain inaccurate information from the limited source and are forced to manage customer information inefficiently.

Member stores first need to obtain approvals from customers to receive accurate personal information from credit card companies, and need to provide services attractive to the customers in return for such approvals. Furthermore, credit companies need to charge member stores certain fees as the credit companies contractually provide customers' personal information they manage only to these member stores.

The aforementioned conventional method does not consider advantages that may be received by customers, member stores and credit companies, and only credit card companies can utilize customers' detail personal information.

### SUMMARY OF THE INVENTION

The present invention provides an electronic settlement method and system where credit card companies, member stores (member sites) and customers can each receive benefits using customers' detail personal information.

In accordance with an embodiment of the present invention, in an electronic settlement system wherein a server of a credit card company and a card-processing device of member stores or a terminal used by customers are connected via a communication line and credit cards are used for settlements, the server sends customers' personal information to the card-processing device when customers, who have approved the use of their personal information by member stores, use their credit cards and the card-processing device performs settlements using the credit cards at the member stores, and the credit card company or member stores provide the customers with preferred services (such as discounts or invitations to special events). When sending the customer personal information to the member stores, the credit card company can charge the member stores fees for providing the information.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 illustrates how credit card companies, member stores, and customers will each receive benefits when credit card companies or member stores provide preferred services.

FIG. 2 illustrates a system structure encompassing customers, member stores, and credit companies and the flow of information and services among them when a credit company mainly provides preferred services.

FIG. 3 illustrates a system structure encompassing customers, member stores, and credit companies and the flow of information and services among them when member stores accommodate particular customers and obtain the customers' personal information from credit card companies.

FIG. 4 shows an example of the structure of a use detail table used by servers at credit card companies.

FIG. 5 shows an example of the structure of a credit account information table used by servers at credit card companies.

FIGS. 6(a), (b) and (c) show a flow chart explaining how member stores register preferred customers, an example of a structure of a preferred customer management table held by credit card companies, and a structure of a preferred customer information table in the system at member stores, respectively.

FIGS. 7(a) and (b) show a flow chart explaining how member stores process settlements and discounts, and an example of how a sales detail table held by member stores is structured, respectively.

FIG. 8 is a block diagram showing a system structure of another embodiment of the present invention where a server at a “credit service member electronic transaction” web site is used to render services.

FIG. 9 shows a flow chart explaining processing operations where requests for preferred services are performed for each member store through servers of the member sites using the system in FIG. 8.

### DETAILED DESCRIPTION OF THE PREFERRED EMBODIMENTS

Electronic settlement methods and electronic settlement systems in accordance with embodiments of the present invention are described in detail with reference to the accompanying drawings. The electronic settlement method and system are generally implemented in two types of transactions where: 1) a card-processing device at member stores is used; and 2) a server of member electronic transaction sites is used. First, a description will be made as to the advantages and benefits credit card companies, member stores (sites) and customers will receive from the present invention.

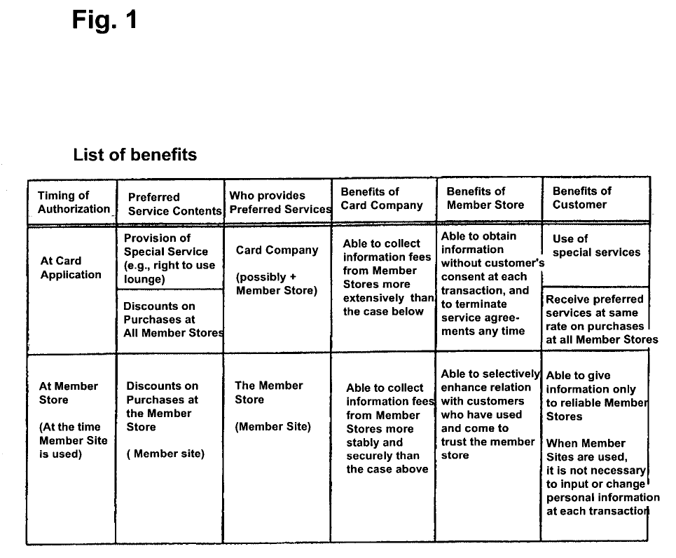

FIG. 1 is a table summarizing how credit card companies, member stores (sites) and customers will each benefit depending on who (credit card companies or member stores) mainly performs preferred services.

If approvals of customers for providing member stores with the customer's personal information are given at the time of credit card applications, a card company will basically be responsible for the preferred services. In this case, the preferred services to the customers that the card company provide include certain services such as the use of VIP lounges in addition to payment discounts. Through the preferred services by the card company, the customers will benefit from receiving discounts at all member stores and/or receiving certain services. Member stores will benefit from receiving personal information of the customers who made purchases without receiving customers' approval each time the customers made purchases. The card company will benefit from possibly receiving fees from the use of personal information from a large number of member stores.

If customers' approval for providing member stores with their personal information is done at the time of purchases (at a member store or site), member stores will be basically responsible for the preferred services. In this case, the customers will benefit from being able to select member stores which the customers can trust and approve the use of personal information. Also, customers who are about to make purchases at a member website benefit from not having to input personal information or to change the pre-registered information necessary for the purchases (as the use of electronic transaction web sites requires the registration of information such as name and address). Member stores (sites) will benefit from having an alternative where they can selectively strengthen relationships with their customers who trusted the member stores and approved the use of personal information, rather than paying fees for the information on all customers who made purchases. Card companies will benefit from reducing their burden by sharing discounts with member stores when accommodating all customer settlements although some member stores may not elect to receive customers' personal information by paying fees.

As mentioned above, if customers' approval for providing member stores with their personal information is given at the time of card applications, card companies will basically be responsible for the preferred services, and if customers' approval for providing member stores with their personal information is done at the time of purchases (at a member store or site), member stores will basically responsible for the preferred services. This is, however, not the case if customers wish to be accommodated by only selected member stores at the time of their applications, or if customers wish an accommodation of the entire settlement or an accommodation only at other member stores. Since this will complicate the explanation, it will not be addressed in the following embodiments.

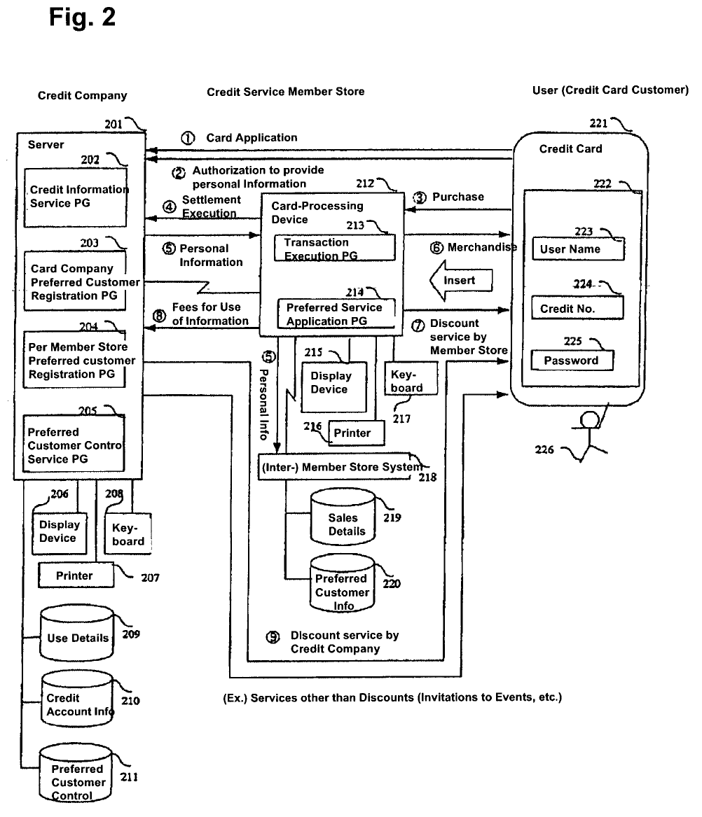

FIG. 2 illustrates the system structure encompassing customers, member stores, and credit companies and the flow of information and services among them when credit card companies mainly provide preferred services, and we will next address an example when a card-processing device of credit companies handles the services. FIG. 2 shows a server 201, a credit information service program 202, a card company preferred customer registration program 203, a per-member store preferred customer registration service program 204, a preferred customer management service program 205, display devices 206 and 215, printers 207 and 216, keyboards 208 and 217, a use detail table 209, a credit account information table 210, a preferred customer management table 211, a card-processing device 212, a transaction execution program 213, a preferred service request program 214, an inter-member store (which may also be referred to as a “member store”) system 218, a sales detail table 219, a preferred customer information table 220, and a credit card 221.

The credit card company has the server 201, and in the server 201, there are credit information service program 202 which performs regular credit settlements, the card company preferred customer registration program 203 which registers preferred customers accommodated mainly by credit card companies, the per-member store preferred customer registration service program 204 which registers certain customers as preferred customers at certain member stores according to a request from member stores or member sites, the preferred customer management service program 205 which processes discounts processes during settlements for the registered preferred customers, the use detail table 209 which records all settlements, the credit account information table 210 which records personal information of all customers, and the preferred customer management table 211 which records which of the preferred customers will be accommodated and how they are accommodated. In addition, the server 201 is accompanied by the display device 206, printer 207, and keyboard 208.

In the discussion above, the “service program” is an unique program which, unlike regular programs, runs after being requested by other programs. The per-member store preferred customer registration service program 204 is activated upon a request from the preferred service request program. A member store has the card processing device 212 connected to credit company's server via a network. The card processing device 212 is equipped with the transaction execution program 213 (which processes settlements by communication) and the preferred service request program 214, accompanied by the display device 215, printer 216 and keyboard 217. Furthermore, personal information about the customer received from the credit card company is sent to the member store system 218 through the card processing device 212. In the member store system 218, there are the sales detail table 219 which records all purchases and the preferred customer information table 220 which records preferred customers' information.

The customer 226 (a card user) owns a credit card 221, in which credit information 222 of this customer is recorded. In this embodiment, the customer name 223, credit number 224 and password 225 are recorded as credit information. When the credit card inserted into the card processing device and a password is input from the keyboard, the credit account information is verified in the card company's server and, if the password is correct, the individual is recognized as the customer.

Next, a description will be made as to the processing flow of the system shown in FIG. 2.

(1) First, the customer 226 applies for a card to a credit card company, and authorizes the credit card company to use his personal information to have a credit card 221 issued. By doing so, the customer will receive discounts from the card company for card settlements at all member stores. In return, the card company can release the customer's personal information to any member stores (where the customer has made credit card settlements). In addition, the personal information released is assigned a level (a degree of details). Customers who agreed to a high level of personal information (i.e., address and annual income) receive preferred services of higher qualities compared to customers who agreed to a lower level of personal information (i.e., name, gender and age). In this step, the card company preferred customer registration program 203, which is in server 201 at the card company, is activated (Step 1, 2)

(2) Afterward, when the customer slides the credit card 221 into a card reader installed in the card processing device 212 at a member store to make a purchase at the member store, the credit information 222 recorded in the card is sent to the server 201 at the card company and a settlement is performed. In this step, the credit information 222 is processed by the transaction execution program 213 in the card processing device 212 and the credit information service program 202 in the server 201 at the card company, and the use detail table 209 is renewed when the credit account information table 210 is referred to (Step 3, 4).

(3) The server 201 at the card company determines if the customer should be accommodated with preferred services, and if the customer is a preferred customer, sends the customer's personal information to the member store system 218 via card processing device 212. This step is a sub-step performed with settlement, and in this step, the preferred customer management service program 205 is activated after the preferred customer management table 211 is referred to. Also, the member store system 218 is activated, and the sales detail table 219 and the preferred customer information table 220 are renewed (Step 5).

(4) Then, the member store gives the customer a merchandise. At this time, some member stores can be a primary party and provide discounts to the customers as a service to that purchase. This case only applies, however, where a customer wishes to receive a higher level of discount and offers a member store a higher level of personal information for the purchase although the customer initially agreed only to providing a relatively low level of his personal information (therefore only requested a low level of discount) and member stores could only receive a low level of information. In this case, for the purchase by the customer, the card company sends the member store a high level of personal information. In return, the member store will share the discount (for a portion of the higher level of the total discount) to the customer (Step 6, 7).

(5) The member store pays a fee to the card company depending on the amount of personal information received. The fee may be determined based on the number and level of personal information received (Step 8).

(6) The card company discounts the settlement amount for the customer. Credit settlements normally withdraw money from the customers' bank account once a month, and this amount will be discounted at a predetermined percentage (Step 9).

(7) The card company can give the customer other services than discounts, such as invitations to specified events, airport lounge uses, and the like, regardless of the purchase behavior at the store (Step Ex).

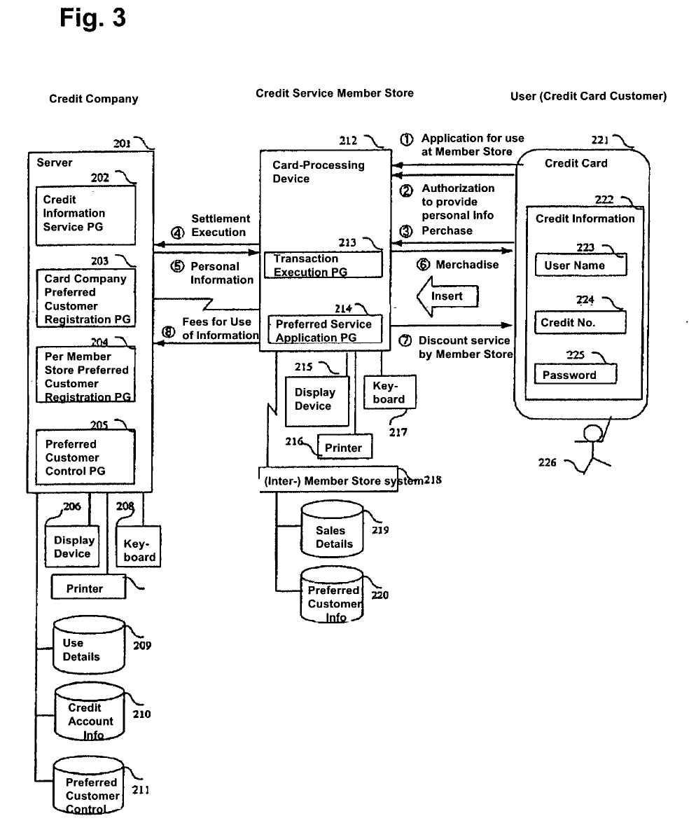

FIG. 3 illustrates a system structure which includes customers, member stores and card companies when member stores become a primary party, who provide preferred services to certain customers and receive the customers' personal information from the card company. FIG. 3 shows a flow of information and services among these three parties. In FIG. 3, the same elements are indicated by the same reference numbers used in the FIG. 2, and the system structure shown in FIG. 3 is basically the same as the system structure shown in FIG. 2.

The example in FIG. 3 is different from the example shown in FIG. 2 in that: 1) a customer agrees to providing a member store with his personal information and requests for preferred services at the member store although the customer initially agreed only to receiving services from a card company (Step 1, 2); 2) though not illustrated, upon the customer's agreement to the use of his personal information, the card processing device 212 notifies this agreement to server 201; and 3) the credit card company can not provide the customer services such as invitations to events, airport lounge uses and the like.

The example in FIG. 3 is a case where a customer wishes a discount service for purchases at certain member stores and agrees to providing certain levels of personal information at these member stores. The member stores provide discount services matching the levels and will pay fees to a card company for the information use, however, the fees are lower than the case where companies are a primary party of discounts since the member store primarily provides discounts in this case.

The aforementioned fees for the information use can be paid from the member store to the card company in various methods based on contractual set-ups between the card company and member store. For instance, based on the number of customers providing their personal information or the level of information, fixed fees can be paid once a month. Or the fees can be paid based on the total number of uses by customers providing their personal information. In such case, unless there are changes in the information contents, the information can be provided as “same as the last time.”

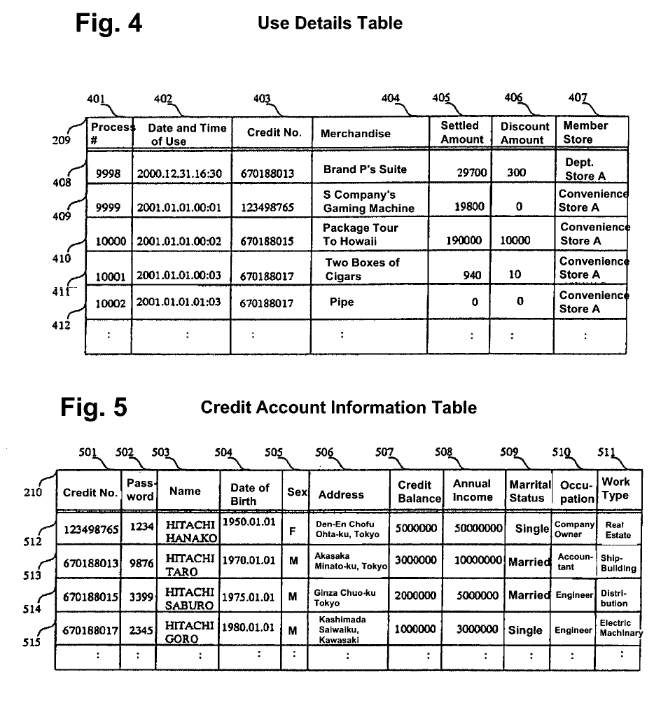

FIGS. 4 and 5 illustrate an example of the structure of a use detail table and a credit account information table, respectively, used by the server of the card company. The following explains these tables.

The use detail table 209 shown in FIG. 4 is structured in a way where records can be stored with the following items: process number 401, use date and time 402, credit number 403, merchandise name 404, settlement amount 405, discount amount 406, member store name 407. In addition, as an example of the tables, five records are shown in the figure. For instance, a record 408 at the process number 9998 shows that the customer with the card number 670188013 purchased a suit made by Company P at a member store, A Department Store, on Dec. 31, 2000 at 4:30 p.m. using his credit card and, after 300 yen was discounted, 29,700 yen was settled. Similarly, a record 409 at the process number 9999 shows that the customer with the card number 123498765 purchased a game equipment made by Company S at a member store, A Convenience Store, on Jan. 1, 2001 at 0:01 a.m. and 19,800 yen was settled without any discount. Amounts settled in the aforementioned situations are generally withdrawn from the customer's bank account, in many cases, once a month as explained earlier.

The credit account information table 210 shown in the FIG. 5 is structured in a way where records can be stored with the following items: credit number 501, password 502, name 503, date of birth 504, gender 505, address 506, credit limit 507, annual income 508, marital status 509, occupation 510, type of work 511. In addition, as an example of the tables, four records are shown in the figure. For instance, a record 512 at the credit number 123498765 shows that the password used for identification is 1234, the customer's name is Hanako Hitachi, her date of birth is Jan. 1, 1950, she is female, and she lives in Den-En Chofu, Ohta-ku, Tokyo. Also, it shows that her annual income is 50 million yen, she is single, owns a real estate company, and the card allows settlements up to 5 million yen (this credit limit will be reduced after each settlement).

Although the process flow is not shown, next we will explain the process the card company performs when the card company register preferred customers. This process is done by the card company preferred customer registration program 203, and in this, the card company registers preferred customers, with whom the card company provides preferred services as a primary party, into the preferred customer management table 211 in the server. A customer approves the use of his personal information when his credit card is made, and sends a signed document to the card company. A staff at the card company, upon receiving this, inputs though a serve keyboard the customer's credit number and service level, thus activates the card company preferred customer registration program 203, and completes the process by preparing a record in the preferred customer management table 211. In the case described above, the card company must guarantee, when the customer agrees to providing his personal information, that the information will not be released to member stores where the customer did not make purchases and the information received by member stores will not be released to other member stores or individuals, and this guarantee needs to be included in the document between the customer and the card company. Also, the card company and all member stores wishing to receive customers' personal information must agree on this point in writing before the service begins.

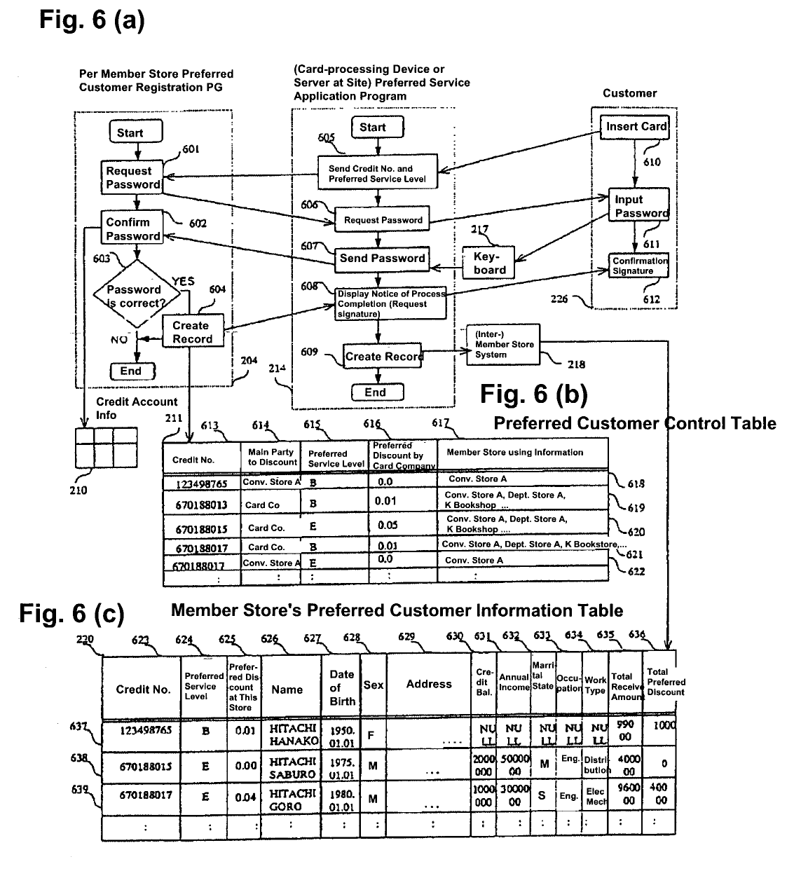

FIGS. 6(a), (b) and (c) show a flow chart explaining the process on how each member store registers preferred customers, an example of the structure of a preferred customer management table held by card companies, and a preferred customer information table in the member store system, respectively.

The table shown in FIG. 6(b) exemplifies data in the preferred customer management table 211 held by the card company. This table consists of multiple records stored, which include credit number 613, discount primary party 614, preferred service level 615, preferred service percentage by card company 616 and member stores using information 617. In this example, personal information sent to a member store have two levels: low level B and high level E. Level B personal information consists of, among the fields in the credit account information table, name, date of birth, gender and address, and Level E personal information consists of, in addition to these four, credit limit, annual income, marital status, occupation, and job type. Preferred services for Level B and Level E are to provide a discount of 1% and 5%, respectively. This percentage will be the same regardless of the primary preferred service providers (card companies or member stores).

The table example in FIG. 6(b) shows that the customer with the credit number 123498765 is a preferred customer requested by Convenience Store A and is a Level B preferred customer (Convenience Store A will discount all merchandises this customer purchases by 1%) and that the card company is not a primary party for the preferred services and there will be no discount for settlements at locations other than Convenience Store A. Furthermore, Convenience Store A is naturally designated as one of the member stores which can receive and use this customer's (Level B) personal information. Similarly, this figure shows that the card company is a primary party to provide Level B and E discounts for the customers with the credit number 670188013 and 670188015, respectively, that these customers' personal information will be used by many member stores (all of whom requested the use) and that, if purchases are made at Convenience Store A, Convenience Store A will be a primary party to provide Level E discounts and only Convenience Store A can receive high level personal information such as credit limit and occupation.

The table shown in FIG. 6(c) exemplifies data in the preferred customer information table 220, and here the table is installed in the inter-store system at a member store, Convenience Store A. This table consists of multiple records stored, which includes credit number 623, preferred service level 624, applicable store discount percentage 625, name 626, date of birth 627, gender, 6328, address 629, credit limit 630, annual income 631, marital status 632, occupation 633, job type 634, accumulated received amount 635, and accumulated preferred service amount 636. In this example, records are stored mainly for the customer's credit number, preferred service level, discount percentage at the member store derived from the preferred service level, personal information received from the card company, and information on how much service the member store performed in the past and what amount it received from the customer. For instance, for the customer with the credit number 123498765, the member store has discounted 1,000 yen so far based on the discount percentage of 1% and has received the total of 99,000 yen to the date, and 4 items of Level B personal information are noted. Also, the customer number with the credit number 670188015 is a level E customer, however, since the card company is a primary party for discounts, Convenience Store A has not given any discounts so far and has received the total of 400,000 yen, and 5 items of Level E personal information in addition to 4 items of Level B information are recorded. In addition, for the customer with the credit number 670188017, 40,000 yen has been discounted so far based on 4% discount rate (Level E-Level B) and both Level B and E personal information are recorded.

FIG. 6(a) shows a flow chart of processes indicating how member stores register their preferred customers. The process flow on the left hand section of the flow chart is performed by the per member store preferred customer registration service program 204 in the server 201. The process flow at the center part is performed by the preferred service request program 214 in a card-processing device at member stores. The right section in the figure indicates customer' actions. Referring to FIG. 6. the process on how a member store registers its preferred customers will be described.

(1) At a member store, if there is a customer who agrees to providing their personal information to the store, a staff at the store inputs the preferred service level with the customer's card being slid into the card processing device 212. By doing so, the preferred service request program 214 at the member store sends the customer's credit number and preferred service level to the per member store preferred service registration service program 204 (Step 610, 605).

(2) Similar to the case where a card company is a primary party for preferred services, the member store needs to guarantee not to release personal information to outside parties, and customers, based on this guarantee, needs to leave an evidence that the customer has agreed to providing his personal information. Therefore, in this example, the per member store preferred service registration service program 204 generates a confirmation message including this guarantee and asks for a password input (Step 601, 606).

(3) A password is one of the customer's credit information, as mentioned above, and is stored in a credit account information table in the credit card and the server of the credit card company. The customer, who reads the message received by the card processing device 212, inputs his password using the keyboard 217 without showing it to others (Step 611).

(4) The per member store preferred service registration service program 204 receives the password via the card processing device 212, confirms the password, verifies the authenticity based on the information in the credit account information 210, and upon authentication, makes records for the customer in the preferred customer management table 211, and determines the discount primary party 614, preferred service level 615 and card company preferred service percentage 616. The card company preferred service percentage, however, will necessarily be set at 0.0 when requests from member stores are processed (Step 607, 602-604).

(5) Next, the per member preferred service registration service program 204 notifies the member store on the completion of the process, prints out 2 copies, asks for the signature by the staff and the customer as well as keeping one copy each at both parties (Step 608, 612)

(6) When both parties exchange the document in the step mentioned above, a contract becomes effective, and preferred services to this customer will start at a purchase immediately thereafter. Also, the member store receives the customer's personal information and adds a record to the preferred customer information table 220 (Step 609).

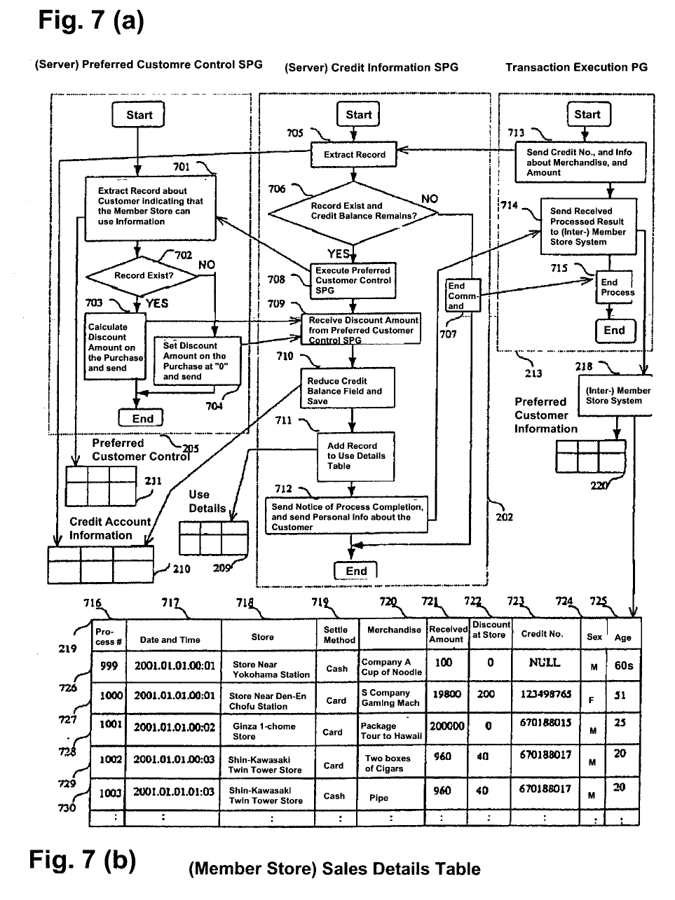

FIGS. 7(a) and (b) show a flow chart explaining the process of settlements and discounts at member stores and a structure of a sales detail table at member stores.

The table in FIG. 7(b) is a table exemplifying data in the sales detail table held by Convenience Store A as a member store. This table consists of multiple records which include items such as process number 716, date and time 717, store name 718, settlement method 719, merchandise name 720, settlement amount 721, at store discount amount 722, credit number 723, gender 724, and age 725. The sales detail table shows, for example, that, in the record number 726 at a process number 999, a customer purchased a cup noodle made by Company A on Jan. 1, 2001 at 0:01 a.m. at a store near the Yokohama Station and paid 100 yen in cash. Furthermore, the record shows that a staff in charge of cash register inputs the data indicating the customer is a male in his 60s (as mentioned above, this information is not necessarily accurate). Also, the record 727 of the processing number 1000 shows that on the same date and time, another customer purchased a computer game made by Company S using the credit card number 123498765 at a store near the Den-En Chofu Station and that Convenience Store A discounted 200 yen from the purchase amount of 20,000 or 1%. In addition, this record includes “a female, 51 years old” which was recorded using personal information sent from a server of the credit company right after the settlement. Similarly, the record 728 of the processing number 1001 shows that on the same day at 0:02 a.m., another customer (25 years old, male) purchased a package trip to Hawaii worth 200,000 yen using the credit card number 670188015 at the Ginza 1-chome Store and no discount was made (in this case, the discount was provided by the credit card company). Also, the record 729 of the process number 1002 shows that on the same day at 0:03 a.m., another customer (20 years old, male) purchased two boxes of cigars using the credit card number 670188017 at the Kawasaki Twin Tower Store and 40 yen out of the purchased price of 1,000 yen or 4% (Level E-Level B) was discounted by the member store. Furthermore, the record 730 of the process number 1003 shows that the same customer purchased a pipe at the same member store and 4% of the total purchase price of 1,000 yen was discounted, however, settlement was done in cash. This occurs when a customer requests both discount and cash settlement at the same time.

FIG. 7(a) shows a flow chart explaining the settlement and discount process where a member store is Convenience Store A. The left part is the process flow performed by the preferred customer management service program 205 in server 201, the middle part is the process flow performed by the credit information service program 202, and the right part is the process flow performed by the transaction execution program 213 at the member store. Next we will explain the settlement and discount processing at the member store.

(1) When a customer goes to a register with a card and merchandise, a staff at the member store inputs information for the merchandise (code) and amount (before discount) and inserts the card into a card-processing device. By this, the transaction execution program 213 is activated and sends the information for the merchandise, amount and credit number of the inserted card to the credit information service program 202 in the credit company's server 201 (Step 713).

(2) The credit information service program 202 extracts the record having the received credit number from the credit account information table 210, and verifies if there is room for the credit limit. By this verification, if there is no room for the credit limit, it sends a completion command to a transaction execution program and completes the processing. If it verifies there is sufficient room, it executes the preferred customer management service program 205 (Step 705-708).

(3) The preferred customer management service program 205 determines if the customer is a preferred customer by referring to the preferred customer management service program 211. In other words, the preferred customer management service program 205, if there is a record indicating that the card company is a primary servicing party for the customer and the member store is designated as an information user member store, calculates the discount amount, sends it to the credit information service program 202. If such record does not exist, the preferred customer management service program 205 determines that the discount will be zero and completes the process by communicating that to the credit information service program 202 (Step 701-704).

(4) The credit information service program 202, after receiving the discount amount that the credit company is supposed to provide from the preferred customer management service program 205, performs a process to save a revised credit limit after subtracting the settlement amount minus the discount from the current credit balance. In addition, it adds a record to the use detail table 209 and completes the process by sending a settlement completion notice and the customer's information (which corresponds to the service level) to the transaction execution program 213 of the member store or member site at the transmitting source if the customer is a (credit company or member store's) preferred customer (Step 709-712).

(5) The transaction execution program 213, which received the customer's personal information, completes the process by sending the information received to the member store system 218. The member store system 218 renews the preferred customer information table 220 using the information received and adds a record to the sales detail table (Step 714, 715). In the case of the record 730 where a preferred customer wanted a cash settlement, a staff at the member store sends the settlement amount as zero with the card being inserted. The use detail table 209 is renewed normally as the amount being zero (record 412 in the FIG. 4) and the customer's personal information is sent to the member store.

The aforementioned example assumed services are performed through a card-processing device at credit service member stores. Next, an explanation is made as to a case where services are performed by a server at credit card service member electronic transaction sites.

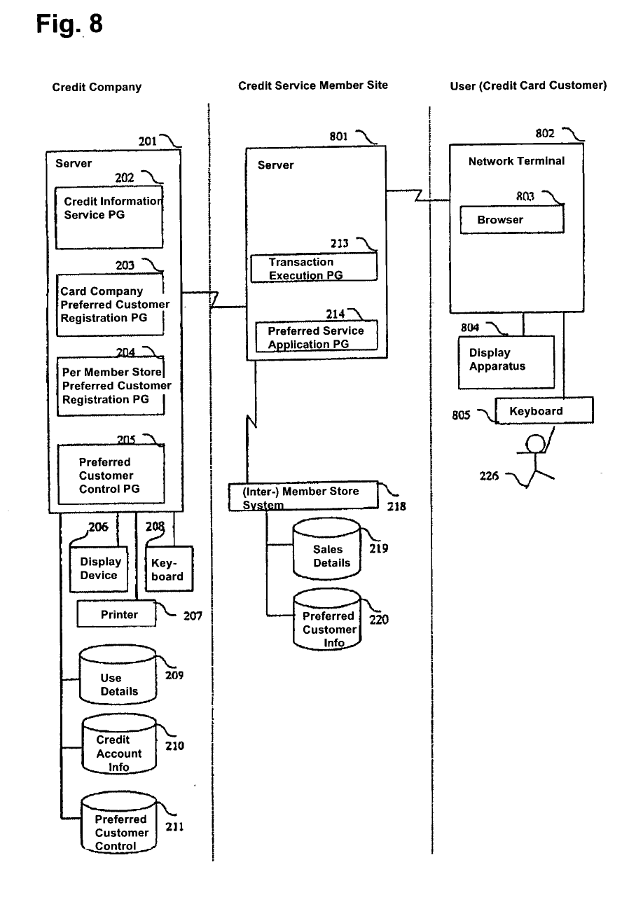

FIG. 8 shows a block diagram showing a structure of another embodiment of the present invention where services are performed by a server at credit card service member electronic transaction sites. FIG. 8 shows a server of member site 801, a network terminal 802, a browser 803, a display device 804, a keyboard 805, and other reference numbers denote the same elements shown in the embodiment indicated in FIG. 2. In the system shown in FIG. 8, the server 801 at the member site carries a transaction execution program 213 and a preferred service request program 214 as the card-processing device 212 shown in FIG. 2 does, and is connected to a sales detail table 219 and a preferred customer information table 220 in the member store system 218. In the meantime, a customer makes purchases by accessing to the site through the browser 803 installed on the network terminal 802 he or she owns and maneuvering the display device 804 and the keyboard 805.

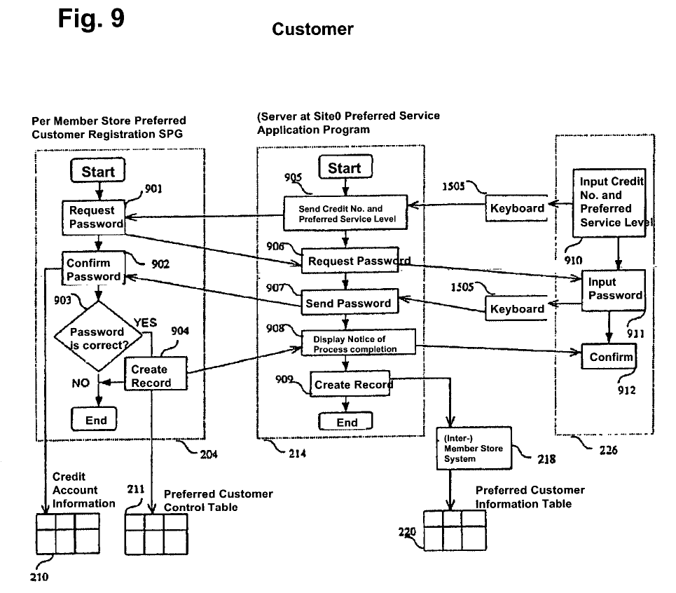

FIG. 9 shows a flow chart explaining the processing actions when an application for preferred services per member store is done through a server of member sites in the system in FIG. 8.

In this process flow, unlike when processes are performed through a card-processing device, the credit number and preferred service level are sent to a server of the card company through a site by the customer's (while watching site screens) inputting from the keyboard 805 (Step 910).

Furthermore, similarly to the case where information was sent via a card-processing device, a passwords is necessary and the customer inputs his password via the keyboard 805 (Step 911). If the password is correct, the process is completed, a confirmation message to the customer is displayed which indicates that future settlements will be discounted and a contact document generated as an evidence (with a signature by the member store staff) will be sent to the customer at the certain date (Step 912).

The aforementioned only explained the processes at the network terminal 802. The processes at the server of the card company are the same as the processes at the server of the card company in the embodiment shown in FIG. 6(a). Also, the processes at the server of the credit company and the server at the site are the same as those described with reference to FIG. 7(a).

Each process at the server of the card company, the card-processing device at the member store, or the server at member site in the embodiments of the present invention discussed earlier can be structured as processing programs and these processing programs can be stored and offered in a recording media such as a HD, DAT, FD, MO, DVD-ROM, and CD-ROM. In the embodiments discussed above, member stores (sites) can obtain personal information of the customers who made purchases, and will be able to run effective sales promotions by focusing customers with certain income level or in certain geographical areas as a result of using the personal information.

The present invention enables credit service member stores or member transaction sites to obtain accurate personal information of the customers who made purchases from card companies and use it to manage customer information effectively. Also, card companies can receive certain fees by sending customers' personal information to member stores or sites.

Furthermore, customers who have a credit card can receive various preferred services from card companies or member stores by agreeing to providing personal information according to the customers decision.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An electronic settlement method where settlements are made by using credit cards through a communication line connecting a server of a credit card company to card-processing devices of member stores or terminals of customers, the electronic settlement method comprising the steps of:
when a customer who agreed to providing personal information of the customer to a member store makes a settlement at the member store using a credit card of the customer through the card-processing device, sending the personal information of the customer to the card-processing device of the member store; and
providing preferred services to the customer by the credit card company or the member store as a primary party to provide the preferred services.

2. An electronic settlement method according to claim 1, further comprising the step of collecting information service fees from the member store for sending personal information of the customer to the member store.

3. An electronic settlement method according to claim 1, wherein, when only specified member stores have an approval to receive personal information of customers, the personal information is sent only to the specified member stores which are approved by the customers.

4. An electronic settlement method according to claim 1, wherein the personal information is classified into levels based on how detail the personal information is.

5. An electronic settlement system where settlements are made by using credit cards through a communication line connecting a server of a credit card company to card-processing devices of member stores or terminals of customers, the electronic settlement system comprising:
a device that, when a customer who agreed to providing personal information of the customer to a member store makes a settlement at the member store using a credit card of the customer through the card-processing device, sends the personal information of the customer to the card-processing device of the member store; and
a device that provides preferred services to the customer by the credit card company or the member store as a primary party to provide the preferred services.

6. An electronic settlement system according to claim 5, further comprising a registering device that registers levels that respectively determine degrees of preferred services to be provided to the customer according to how detail the personal information is authorized by the customer to be released.

7. An electronic settlement system according to claim 6, further comprising a determining device that determines an authorization by the customer to release a higher level of the personal information to thereby provide the preferred services of higher qualities than qualities of the preferred services when the device determines an authorization by the customer to release a lower level of the personal information.

8. An electronic settlement system according to claim 5, further comprising a device that sends credit information of the customer from the card-processing device of the member store to the server of the credit card company at the time of the purchase, and a device that determines if the customer is to be accommodated with the preferred services.

9. An electronic settlement system according to claim 7, wherein the determining device allows the preferred services at a relatively low level to be given at any of the member stores if an authorization is initially given to the credit card company to release a relatively low level of the personal information of the customer.

10. An electronic settlement system according to claim 7, wherein the determining device allows the preferred services at a relatively high level to be given at any of the member stores if an authorization is initially given to the credit card company to release a relatively high level of the personal information of the customer.

11. An electronic settlement method where settlements are made by using credit cards through a communication line connecting a server of a credit card company to card-processing devices of member stores, the electronic settlement method comprising the steps of:
authorizing the credit card company to provide personal information of the customer to a member store prior to making a settlement at the member store using a credit card of the customer through the card-processing device;
sending the personal information of the customer to the card-processing device of the member store when making a settlement at the member store using the credit card of the customer;
providing preferred services to the customer by the credit card company or the member store as a primary party to provide the preferred services.

12. An electronic settlement method according to claim 11, wherein the step of authorizing includes the step of registering levels that respectively determine degrees of preferential services to be provided to the customer according to how detail the personal information is authorized by the customer to be released.

13. An electronic settlement method according to claim 11, further comprising the steps of sending credit information of the customer from the card-processing device of the member store to the server of the credit card company at the time of the purchase, and determining at the server of the credit card company if the customer is to be accommodated with the preferred services.

14. An electronic settlement method according to claim 11, wherein the step of authorizing includes the step of authorizing the credit card company to release a higher level of the personal information to thereby obtain the preferred services of higher qualities compared to authorizing to release a lower level of the personal information.

15. An electronic settlement method according to claim 14, wherein the step of authorizing includes the step of initially authorizing the credit card company only to provide a relatively low level of the personal information of the customer to receive the preferred services at a relatively low level at any of the member stores.

16. An electronic settlement method according to claim 14, wherein the step of authorizing includes the step of initially authorizing the credit card company only to provide a relatively high level of the personal information of the customer to receive the preferred services at a relatively high level at any of the member stores.

17. An electronic settlement method according to claim 14, wherein the step of authorizing includes the steps of initially authorizing the credit card company only to release a relatively low level of the personal information of the customer to receive the preferred services at a relatively low level at any of the member stores, later requesting to receive a higher level of the preferred services by providing a higher level of personal information for a purchase at the member store, receiving the personal information from the credit card company, sharing the preferred services between the member store and the credit card company.

18. An electronic settlement method according to claim 11, further comprising the step conducted by the member store of paying a fee to the credit card company according to the personal information received.

19. An electronic settlement method according to claim 18, wherein the fee is determined based on the amount and level of the personal information received.

20. An electronic settlement method according to claim 11, wherein the step of authorizing includes the step of authorizing only specified member stores to receive the personal information of the customer, and the step of sending includes the step of sending the personal information only to the specified member stores authorized.
